(19) United States
(12) Patent Application Publication
(10) Pub. No.: US 2009/0239191 A1
(43) Pub. Date: Sep. 24, 2009

(54) SECURING SYSTEM

(76) Inventors: Helmut Wurm, Schwarzsee (CH); Dominique Heini, St-Prex (CH); Guillaume Gras, Morges (CH); Frederic Lehner, Puplinge (CH)

Correspondence Address: OSTROLENK FABER GERB & SOFFEN, 1180 AVENUE OF THE AMERICAS, NEW YORK, NY, 100368403, US

(21) Appl. No.: 12/404,801

(22) Filed: Mar. 16, 2009

(30) Foreign Application Priority Data
Mar. 18, 2008 (DE) 10 2008 014 667.6

(51) Int. Cl. A61C 3/00

(52) U.S. Cl. 433/50

(57) ABSTRACT

Securing system for securing a medical instrument on a holding device, wherein the medical instrument can be coupled to the holding device by means of a tapering part of the holding device or of the medical instrument, which is adapted for being brought into engagement with a substantially shape-congruent part of the other one of the medical instrument or holding device.

### CROSS-REFERENCE TO RELATED APPLICATIONS

The present application claims priority of DE 10 2008 014 667.6 filed Mar. 18, 2008, incorporated by reference.

### BACKGROUND

1. Technical Field

The present invention relates to a securing system for securing a medical instrument on a holding device, to a medical instrument, in particular a dental instrument for removing tartar or treating periodontitis, and to a holding device for a medical instrument, in particular a handpiece for a dental instrument for removing tartar or treating periodontitis.

2. Related Art

Securing systems of the type in question have long been known from the prior art. These are used in particular for connection between a handpiece and a scaler, i.e. an instrument for removing tartar or for treating periodontitis. Previous systems are in particular designed with an end section of the medical instrument having a thread which is screwed onto a corresponding holding device until the front face of the end of the medical instrument on which the thread is formed comes into contact with a corresponding abutment surface of the holding device. A problem with these systems, however, is that the connection of the two elements is often unreliable, that is to say in particular that the two elements come loose from each other during use. This is especially the case when the medical instrument is subjected to ultrasonic oscillations. If the elements are intended to have a channel for the passage of a fluid, the known systems often tend to leak, since the connection site does not have a sufficient seal.

### SUMMARY

The object of the present invention is therefore to provide a securing system for securing a medical instrument on a holding device, a medical instrument, in particular a dental instrument for removing tartar or treating periodontitis, and a holding device for a medical instrument, in particular a handpiece for a dental instrument for removing tartar or treating periodontitis, all of which ensure that the medical instrument is secured reliably on the holding device.

This object is achieved by a securing system for securing a medical instrument on a holding device having the features disclosed herein; by a medical instrument, in particular a dental instrument for removing tartar or treating periodontitis, having the features disclosed herein and by a holding device for a medical instrument, in particular a handpiece for a dental instrument for removing tartar or treating periodontitis, having the features disclosed herein. Preferred embodiments are set forth in following description.

According to the invention, a securing system for securing a medical instrument on a holding device is provided, wherein the medical instrument can be coupled to the holding device by means of a tapering part of the holding device or of the medical instrument being able to be brought into engagement with a substantially shape-congruent part of the remaining medical instrument or holding device. A securing system is thus made available by means of which a medical instrument, used in particular for dental treatment, can be secured on a holding device advantageously designed as a handpiece. The medical instrument can be designed in particular as a scaler which, during operation, is preferably subjected to oscillations, preferably ultrasonic oscillations. This is done indirectly or directly via the holding device, which can be designed as part of a handpiece that is held by the user during the treatment. It will be appreciated that the medical instrument can also be, for example, an ultrasonic lithotriptor or some kind of orthopaedic tool. On the holding device or on the medical instrument, there is advantageously a tapering part or area or section which can be brought into engagement with a substantially shape-congruent part or area or section of the remaining element, i.e. of the medical instrument or of the holding device. The tapering part is designed in this case in such a way that it tapers substantially in the direction of a distal end of the corresponding element (i.e. of the medical instrument or of the holding device). In particular, the tapering part forms the distal end of the corresponding element. The tapering part can advantageously have a design that is substantially rotationally symmetrical about a longitudinal axis of the element. In other words, the tapering part can be arranged substantially concentrically about the longitudinal axis. The medical instrument can in particular be designed in one piece, i.e. as a single component part. The same applies to the holding device. By way of the tapering part or area, corresponding sections of the medical instrument and of the holding device contact each other in such a way that this contact area is leaktight with respect to a fluid. The friction between the contacting surfaces or areas ensures that the elements are safely connected to each other and cannot come loose from each other during operation. Finally, the securing system according to the invention has the effect that the elements centre themselves with respect to each other by virtue of the engagement of the tapering part with a corresponding and substantially shape-congruent part. The expression “substantially shape-congruent” is to be understood here in particular as meaning that at least part of the outer surface of one element corresponds to part of the inner surface of the remaining element, such that the elements (i.e. the medical instrument and the holding device) match each other in this area.

For this purpose, advantageously, a contact area is provided on the medical instrument, and a contact section, which can be brought into contact therewith, is provided on the holding device. In the mutually secured state, the contact area and the contact section contact each other in such a way that they are preferably in surface contact with each other.

The tapering part is expediently formed on the contact area or on the contact section. This advantageously has the effect that the medical instrument and the holding device contact each other at least in the area of the tapering part and the corresponding opposite area of the other element, such that the sealing action is achieved in particular by this area. The contact area and/or the contact section, at least the contacting surfaces thereof, are expediently designed to be substantially rotationally symmetrical about the longitudinal axis of the respective element.

The tapering part advantageously has a cone-shaped configuration. The tapering part can thus have a frustoconical configuration, wherein the circumferential surface of the tapering part, in a cross-sectional surface lying parallel to the longitudinal axis of the element, can be designed straight, as a juxtaposition of a plurality of straight lines, or curved, preferably round. The frustoconical configuration advantageously has the effect that the two elements centre themselves with respect to each other during their assembly. Here, the conical bearing surface can be designed in terms of its size, but also in terms of its inclination with respect to the longitudinal axis of the elements, depending on its intended use. The greater the angle of taper (i.e. the angle of the circumferential surface to the longitudinal axis of the tapering part) or the cone angle, the more rigid is the securing of the medical instrument on the holding device. Consequently, the degree of securing is effectively adjustable. It has proven particularly expedient here to use angles of about 2 to 35°, preferably of about 3 to 25°, and particularly preferably of about 4 to 10°. In a cross section seen substantially transverse or perpendicular or at right angles to the longitudinal axis of the tapering part, the latter can have any desired configuration, preferably polygonal, curved, and particularly expediently round.

Moreover, the medical instrument and the holding device are preferably designed as hollow bodies for the passage of a fluid. The elements (i.e. the medical instrument and the holding device) thus have a passage or channel, such that they are designed substantially as a tube or tubular. Therefore, the contact area and the securing area are particularly advantageously formed on an inner circumferential surface of the elements designed as hollow bodies.

In a preferred embodiment, a securing area is provided on the medical instrument, and a securing section, which can be brought into engagement therewith, is provided on the holding device. Securing area and securing section are in this case preferably designed to be substantially rotationally symmetrical about the longitudinal axis of the respective element, and deviations from the rotational symmetry on account of the formation of a thread in this area are negligible.

Advantageously, the longitudinal axis or line of rotational symmetry of the contact area corresponds substantially to the longitudinal axis or line of rotational symmetry of the securing area. The same also applies for the contact section and securing section of the holding device.

The securing area and the securing section expediently each have engagement means for mutual engagement. The advantageously releasable securing of the medical instrument on the holding device is thus obtained through engagement of the respective engagement means. The sealing function, by contrast, is provided by the tapering part being in contact with the corresponding and substantially shape-congruent part of the other element.

The engagement means of the securing section are advantageously arranged on the outside. In other words, the engagement means of the securing section can be formed on an outer circumferential surface of the holding device.

Correspondingly, the engagement means of the securing area can be formed on the inner circumferential surface of the medical instrument designed as a hollow body.

The engagement means are preferably designed as a screw thread in the form of a trapezoidal thread. This permits a particularly large contact surface between the elements in their area of engagement such that, upon excitation of the instrument, corresponding oscillations can be transmitted in a particularly optimal manner. In addition, a trapezoidal thread, compared to a conventional V-shaped thread, allows considerably higher forces to be transmitted.

The screw thread preferably has fewer than six, preferably fewer than four, and particularly preferably two thread turns. A short thread of this kind further improves the operability of the securing system.

In another preferred embodiment, the medical instrument has a deformation area between securing area and contact area. The deformation area serves in particular for an expansion of the medical instrument in this area during attachment to the holding device, where the oscillation excitation of the medical instrument, for example by ultrasound, additionally causes continuing, superposed and alternating expansion. However, the sum of all the expansions, resulting from the pretensioning and from the oscillation-induced expansion, should in this case preferably be greater than zero at each point of the oscillation period. This advantageously has the result that there is phase coincidence of the oscillations of the tapering part and of the securing section or securing area, such that no relative movement is possible between holding device and medical instrument. This leads to a particularly advantageous sealing of the two elements relative to each other and to a particularly reliable securing or connection.

Correspondingly, the holding device can have a deformation section between securing section and contact section.

The product of the cross-sectional surface of the deformation area and elastic modulus of the material of the medical instrument is expediently substantially equal to the product of the cross-sectional surface of the deformation section and elastic modulus of the material of the holding device. The product of the cross-sectional surface of the deformation area and elastic modulus of the material of the medical instrument can advantageously be about 0.7 to about 1.4 here, preferably about 0.85 to about 1.2, and particularly advantageously about 0.95 to about 1.05 times the product of the cross-sectional surface of the deformation area and elastic modulus of the material of the holding device. Irrespective of the choice of material of the elements, this ensures particularly reliable securing and leaktightness of the elements relative to each other.

Moreover, according to the invention, a medical instrument, in particular a dental instrument for removing tartar or treating periodontitis, is provided which comprises a treatment area and an attachment area for securing on a holding device, wherein the attachment area has a tapering part in order to be brought into engagement with a substantially shape-congruent part of the holding device. The medical instrument can expediently be a scaler, which is used to remove tartar or to treat periodontitis, in particular to remove tartar. For this purpose, the medical instrument has a treatment area which is provided in particular at a distal end or end area and via which the treatment of the patient takes place. At an area lying substantially opposite from this one, the medical instrument has an attachment area for securing it on a corresponding holding device of part of a handpiece.

A contact area is expediently provided on the medical instrument, on which area the tapering part is formed.

The tapering part advantageously has a cone-shaped configuration.

Moreover, the medical instrument is advantageously designed as a hollow body for passage of a fluid.

A securing area is expediently provided with engagement means for creating an engagement with the holding device. The engagement means of the securing area are preferably formed on an inner circumferential surface of the medical instrument designed as a hollow body, and they are also expediently designed as a screw thread in the form of a trapezoidal thread. The screw thread can have fewer than six, preferably fewer than four, and particularly preferably two thread turns in this case.

In another preferred embodiment, a deformation area is provided between securing area and contact area. It will be appreciated that the further advantages and features of the securing system according to the invention can likewise be used in the medical instrument according to the invention.

Moreover, according to the invention, a holding device for a medical instrument, in particular a handpiece for a dental instrument for removing tartar or treating periodontitis, is provided which comprises an attachment section with a tapering part in order to be brought into engagement with a substantially shape-congruent part of the medical instrument.

It will be appreciated that the further advantages and features of the securing system according to the invention and of the medical instrument according to the invention can also be used in the holding device according to the invention.

Other features and advantages will become apparent from the following description of embodiments, which refers to the accompanying drawings.

### BRIEF DESCRIPTION OF THE DRAWINGS

Further advantages and features of the invention are set forth in the following description of preferred illustrative embodiments of the invention, it being possible for individual features and aspects of different embodiments to be combined with one another to form new embodiments. In the drawing:

FIG. 1 shows a perspective view of a preferred embodiment of the medical instrument according to the invention;

FIG. 2 shows a cross-sectional view of a part of a preferred embodiment of the instrument according to the invention;

FIG. 3 shows a cross-sectional view of a preferred embodiment of the holding device according to the invention.

### DETAILED DESCRIPTION

In a preferred illustrative embodiment, the securing system is used to secure a medical instrument 2 on a holding device 4. The medical instrument 2 and holding device 4 are coupled to each other here in such a way that they are securely connected to each other and do not come apart during operation, and they are connected to each other in such a way as to be leaktight at their contact surface.

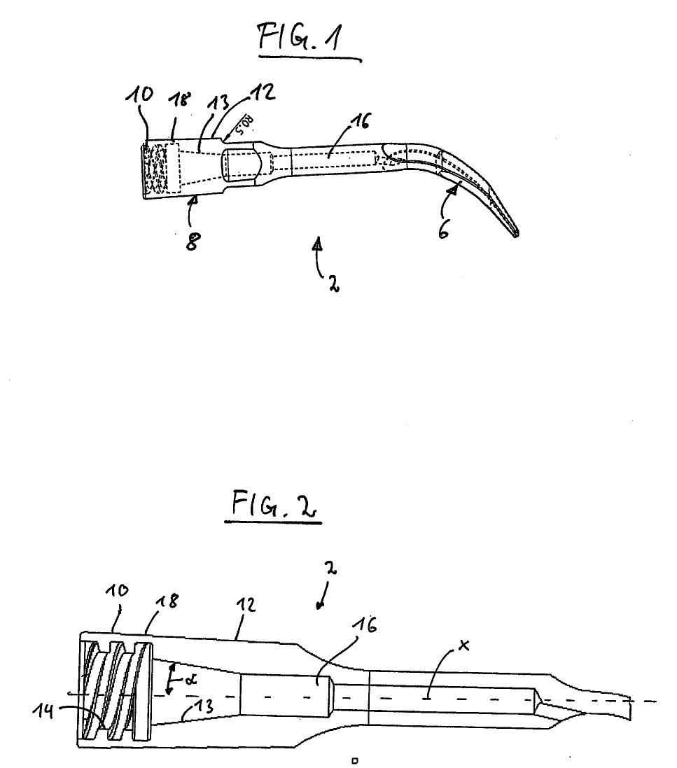

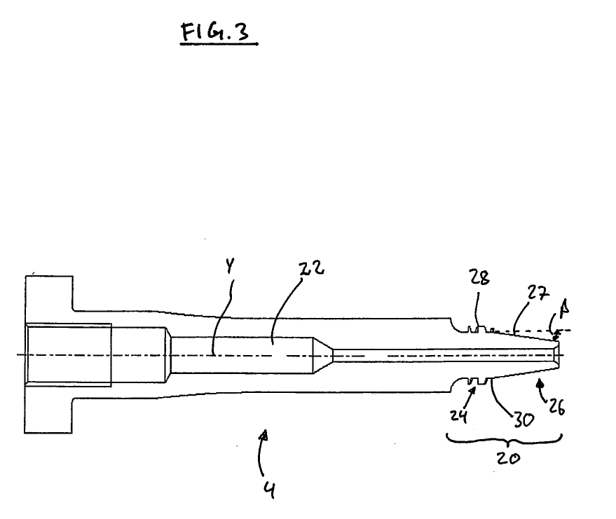

An illustrative embodiment of the medical instrument 2 according to the invention is shown in FIGS. 1 and 2. The medical instrument 2 has a treatment area 6 and an attachment area 8. The treatment area 6 is located substantially at a distal end or an end area of the medical instrument 2 and is used to treat a patient. The treatment area 6 can in particular have a curved, pointed configuration.

The attachment area 8 is provided for attaching and securing the medical instrument 2 to the holding device 4. For this purpose, the attachment area 8 has a securing area 10 and a contact area 12.

The securing area 10 is formed at an end of the medical instrument 2 substantially opposite to the treatment area 6 and has engagement means 14 for engagement with corresponding means on the holding device 4. The medical instrument 2 is designed as a hollow body and has a channel 16 for passage of a fluid, for example an irrigation fluid, along a longitudinal axis X. The engagement means 14 are provided here at a distal end of the medical instrument 2, on the inner circumferential surface of the medical instrument 2. The engagement means 14 are here designed as a thread, particularly in the form of a trapezoidal thread. Because of its straight flanks, the trapezoidal thread expediently has a large contact surface and, compared to a normal V-shaped thread, can absorb considerably greater forces. The flank angles of the trapezoidal thread expediently lie in a range of between about 16° and about 85°, preferably of between about 70° and about 80°, and particularly preferably about 75°.

In the embodiment shown, the screw thread has two thread turns, as a result of which the attachment of the medical instrument 2 to the holding device 4 can be made simpler, with sufficiently reliable attachment being afforded by the trapezoidal thread.

The contact area 12 is provided on the inner circumferential surface of the medical instrument 2 designed as a hollow body. As can be seen, the contact area 12 is designed as a tapering part, the contact area 12 tapering in the direction of the treatment area 6 of the medical instrument 2. In other words, the contact area 12 widens in the direction of the securing area 10. The contact area 12 or the tapering part thereof expediently has an angle or cone angle α with respect to the longitudinal axis X of the medical instrument 2 of about 8°. It has been shown that angles of about 2° to about 35°, preferably about 3° to about 20°, and particularly preferably about 4° to about 10° are particularly advantageous. This is because the cone angle α determines the firmness with which the medical instrument 2 is secured on the holding device 4.

The contact area 12 is designed to make contact with a substantially shape-congruent part of the holding device, in order to ensure that the medical instrument 2 and the holding device 4 are sealed off relative to each other in their connection area.

Between securing area 10 and contact area 12, the medical instrument 2 expediently has a deformation area 18 which is subjected to tensile stress when a medical instrument 2 is mounted on the holding device 4.

FIG. 3 shows a preferred embodiment of the holding device according to the invention. The holding device 4 has an attachment section 20 via which the medical instrument 2 is secured, mounted or arranged on the holding device 4. Like the medical instrument 2, the holding device 4 is also designed as a hollow body, a channel 22 being provided which extends along a longitudinal axis Y and is in fluid communication with the channel 16 such that a fluid delivered to the channel 22 is conveyed into the channel 16 of the medical instrument and emerges at the treatment area 6 thereof.

In order to secure the medical instrument 2 on the holding device 4, the holding device 4 has, in the area of the attachment section 20, a securing section 24 and a contact section 26.

The securing section 24 comprises engagement means 28 which can be brought into engagement with the engagement means 14 of the medical instrument 2. The engagement means 28 are expediently designed as a screw thread, said screw thread preferably being provided in the form of a trapezoidal thread with two thread turns. In this way, it is possible for the two elements to be joined together easily and with a high degree of reliability. The contact section 26 has a tapering part 27, which has a cone-shaped configuration. The cone angle β of the circumferential surface of the tapering part 27 with respect to the longitudinal axis Y of the holding device 4 corresponds substantially to the cone angle α of the medical instrument 2. This ensures substantial surface contact between the contact area 12 and the contact section 26, as a result of which particularly effective leaktight sealing of the connection is ensured. The tapering part 27 here tapers towards the distal end of the holding device 4, which is connected to the medical instrument 2.

Between the securing section 24 and the contact section 26, the attachment section 20 also has a deformation section 30 which, when a medical instrument 2 is mounted on the holding device 4, is subjected to tensile stress oriented parallel to the longitudinal axis Y.

The medical instrument 2 and the holding device 4 can be made of any desired materials, even of different materials. The medical instrument 2 is particularly advantageously made of steel, whereas the holding device 4 is made of titanium.

To ensure reliable sealing and securing during use of the elements, the cross section transverse to or substantially perpendicular to the longitudinal axis X of the medical instrument 2 in the area of the deformation area 18, and the cross section transverse to or substantially perpendicular to the longitudinal axis Y of the holding device 4 in the area of the deformation section 30, are chosen such that the product of the cross-sectional surface of the deformation area 18 and elastic modulus of the material of the medical instrument 2 is about 0.8 to about 1.2, preferably about 0.9 to about 1.1, and particularly preferably about equal to the product of the cross-sectional surface, substantially perpendicular to the longitudinal axis Y, of the deformation section 30 and elastic modulus of the material of the holding device 4.

### LIST OF REFERENCE SIGNS

2 medical instrument
4 holding device
6 treatment area
8 attachment area
10 securing area
12 contact area
13 tapering part
14 engagement means
16 channel
18 deformation area
20 attachment section
22 channel
24 securing section
26 contact section
27 tapering part
28 engagement means
30 deformation section
α cone angle
β cone angle
X longitudinal axis
Y longitudinal axis

Although particular embodiments have been described, many other variations and modifications and other uses will become apparent to those skilled in the art. Therefore, the present invention is not limited by the specific disclosure herein.

1. Securing system for securing a medical instrument on a holding device, wherein the medical instrument can be coupled to the holding device by means of a tapering part on one of the holding device and the medical instrument, being able to be brought into engagement with a substantially shape-congruent part of the other of the medical instrument and the holding device.

2. Securing system according to claim 1, wherein a contact area is provided on the medical instrument, and a contact section, which can be brought into contact therewith, is provided on the holding device.

3. Securing system according to claim 2, wherein the tapering part is formed on the contact area or on the contact section.

4. Securing system according to one claims 1-3, wherein the tapering part has a cone-shaped configuration.

5. Securing system according to claim 1, wherein the medical instrument and the holding device comprise hollow bodies for the passage of a fluid.

6. Securing system according to claim 1, wherein a securing area is provided on the medical instrument, and a securing section, which can be brought into engagement therewith, is provided on the holding device.

7. Securing system according to claim 6, wherein the securing area and the securing section each have engagement means for mutual engagement.

8. Securing system according to claim 7, wherein the engagement means of the securing section are arranged on the outside.

9. Securing system according to claim 8, wherein the engagement means of the securing area are formed on an inner circumferential surface of the medical instrument designed as a hollow body.

10. Securing system according to one of claims 7-9, wherein the engagement means comprise a screw thread in the form of a trapezoidal thread.

11. Securing system according to claim 7, wherein the engagement means comprise a screw thread, and wherein the screw thread has fewer than six thread turns.

12. Securing system according to claim 6, wherein the medical instrument has a deformation area between securing area and contact area.

13. Securing system according to claim 6, wherein the holding device has a deformation section between securing section and contact section.

14. Securing system according to one of claims 12 and 13, wherein the product of the cross-sectional surface of the deformation area and the elastic modulus of the material of the medical instrument is about 0.7 to about 1.4 times the product of the cross-sectional surface of the deformation section and elastic modulus of the material of the holding device.

15. Medical instrument, in particular a dental instrument for removing tartar or treating periodontitis, comprising a treatment area and an attachment area for securing on a holding device, wherein the attachment area has a tapering part in order to be brought into engagement with a substantially shape-congruent part of the holding device.

16. Medical instrument according to claim 15, wherein a contact area is provided on the medical instrument, on which area the tapering part is formed.

17. Medical instrument according to one of claims 15-16, wherein the tapering part has a cone-shaped configuration.

18. Medical instrument according to claim 15, comprising a hollow body for the passage of a fluid.

19. Medical instrument according to claim 16, wherein a securing area is provided with engagement means for creating an engagement with the holding device.

20. Medical instrument according to claim 19, wherein the engagement means of the securing area are formed on an inner circumferential surface of the medical instrument comprising a hollow body.

21. Medical instrument according to one of claims 19 and 20, wherein the engagement means comprise a screw thread in the form of a trapezoidal thread.

22. Medical instrument according to claim 21, wherein the screw thread has fewer than six thread turns.

23. Medical instrument according to claim 19, wherein a deformation area is provided between securing area and contact area.

24. Holding device for a medical instrument, in particular a handpiece for a dental instrument for removing tartar and treating periodontitis, comprising an attachment section with a tapering part for being brought into engagement with a substantially shape-congruent part of the medical instrument.

25. Securing system according to claim 7, wherein the engagement means of the securing area are formed on an inner circumferential surface of the medical instrument designed as a hollow body.

26. Securing system according to claim 25, wherein the engagement means comprise a screw thread in the form of a trapezoidal thread.

27. Securing system according to claim 11, wherein the screw thread has fewer than four thread turns.

28. Securing system according to claim 27, wherein the screw thread has two thread turns.

29. Securing system according to claim 14, wherein said product is about 0.85 to about 1.2.

30. Securing system according to claim 29, wherein said product is about 0.95 to about 1.05.
